(19) United States
(12) Patent Application Publication
(10) Pub. No.: US 2008/0121666 A1
(43) Pub. Date: May 29, 2008

(54) Multi-Component Valve Stems

(76) Inventor: Graham R. Purkins, Leicestershire (GB)

Correspondence Address: 3M INNOVATIVE PROPERTIES COMPANY, PO BOX 33427, ST. PAUL, MN, 55133-3427, US

(21) Appl. No.: 10/561,655

(22) PCT Filed: Jun. 14, 2004
(86) PCT No.: PCT/US04/18804

§ 371 Date: Dec. 20, 2005

(30) Foreign Application Priority Data
Jul. 7, 2003 (GB) 0315801.1

(51) Int. Cl. B65D 83/14; B29C 45/00; F16K 21/16; F16K 51/00

(52) U.S. Cl. 222/402.2; 251/356; 29/890.123

(57) ABSTRACT

A valve stem (13) for use with a metering valve, said valve stem (13) comprising an elongate stem element (12) having an elastomeric sleeve (9) molded onto at least a portion thereof and a sealing element (16) having an inner surface (7), said sealing element (16) being affixed onto the elongate stem element (12), such that at least a portion of the inner surface (7) of the sealing element (16) is overlying at least a portion of the elastomeric sleeve (9); as well as methods of manufacturing such a valve stem.

### FIELD

The present invention relates to valve stems for metered dose dispensing valves for dispensing metered volumes of a pressurized aerosol formulation, in particular medicinal aerosol formulations, from an aerosol container.

### BACKGROUND

Metering valves are particularly useful for administering medicinal formulations that include a liquefied gas propellant and are delivered to a patient in an aerosol for inhalation, nasal, or sublingual administration.

Medicinal aerosol formulations generally comprise medicament, one or more propellants, (e.g. chlorofluorocarbons and more recently hydrogen-containing fluorocarbons, such as 1,1,1,2-tetrafluoroethane (HFA 134a) and 1,1,1,2,3,3,3-heptafluoropropane (HFA 227)) and possibly excipients, such as surfactant and/or a solvent, such as ethanol.

When administering medicinal formulations, a dose of formulation sufficient to produce the desired physiological response is delivered to the patient. The proper predetermined amount of the formulation must be dispensed to the patient in each successive dose. Thus, any dispensing system must be able to dispense doses of the medicinal formulation accurately and reliably over the shelf life of the medicinal product to help assure the safety and efficacy of the treatment.

Metering dose valves typically comprise an elongate outlet member or valve stem movable between closed and dispensing positions.

The metering valves typically used in commercially available aerosol inhalers, comprise a fixed metering chamber and a valve stem that slides through a diaphragm, also known as an outer stem gasket or seal, mounted in a fixed manner on the valve body of the valve.

However, in some other metering valves, the valve stem may comprise an annular elastomeric seal capable of forming a fluid-tight seal with a portion of the wall of the chamber or valve body. In particular, one or more annular seals may be arranged onto a portion of the elongate stem element of the valve stem. Examples of such metering valves include various embodiments of shuttle-type metered dose dispensing valves disclosed in U.S. Pat. No. 5,772,085. Other examples include certain embodiments of our co-pending U.S. provisional application 60-408637 filed on Sep. 6, 2002.

### SUMMARY OF THE INVENTION

It is to be appreciated that in the metering valves of the latter type, i.e. including a valve stem comprising a sealing element, the sealing element is moving with the valve stem, each and every time the valve stem moves to and from its dispensing position during the operation or firing of the dispensing device. In particular, it has been noted that for valve stems having a (e.g. an annular elastomeric) sealing element mechanically affixed onto the elongate stem element, there may be a tendency towards the formation of a leakage path at the interface between the elongate stem and sealing element. Tendency towards leakage in turn may disadvantageously reduce the accuracy and reliability of the metered dose dispensing valve comprising such a valve stem. Our co-pending U.S. application 60-408637 discloses the use of processes in which the elongate stem element and the sealing element are co-molded to manufacture the valve stem.

Although such co-molding of the elongate stem and sealing elements is advantageous in that it allows the provision of a chemical and/or mechanical bond between the respective components and thereby minimizes leakage, we have found that due to material and/or structural considerations the application of such co-molding is not always feasible or practical. For example, the sealing element may have a complex geometry precluding the application of co-molding, or the desired or needed materials selected for the sealing and elongate stem elements may preclude the use of co-molding. Thus, there is an ongoing need to provide valve stems for metered dose dispensing valves comprising mechanically affixed sealing elements showing a desirably, minimal or no tendency towards leakage in use and thus superior performance properties for use in metered dose dispensing valves for the delivery of medicament.

We have now found that by providing an elastomeric sleeve molded onto the elongate stem element and located, desirably circumferentially, between, at least a portion of the interface between the elongate stem element and the sealing element affixed thereto, a valve stem having enhanced resistance to leakage as well as desirable robustness, e.g. over a typical lifetime-use in a metering valve, can be provided, while at the same time allowing for a broad freedom in material selection and/or structural design for the elongate stem and sealing elements.

Accordingly, one aspect of the present invention provides a valve stem for use with a metering valve, said valve stem comprising an elongate stem element having an elastomeric sleeve molded onto at least a portion thereof and a sealing element having an internal surface, said sealing element being affixed onto the elongate stem element, such that at least a portion of the internal surface of the sealing element is overlying at least a portion of the elastomeric sleeve.

In another aspect the present invention provides a method of manufacturing a valve stem for use with a metering valve, said valve stem comprising an elongate stem element, an elastomeric sleeve and a sealing element, said method comprising the steps of:
a) providing an elongate stem element;
b) providing a mold shape containing at least in part the elongate stem element;
c) molding a material to form the elastomeric sleeve, such that the elastomeric sleeve is molded onto at least a portion of the elongate stem element; and
d) affixing the sealing element onto the elongate stem element, such at least a portion of the inner surface of the sealing element is overlying at least a portion of the elastomeric sleeve.

In further aspects, the invention provides a metered dose dispensing valve comprising such a valve stem as well as a metered dose dispenser comprising a container equipped with such a metered dose valve.

The dependent claims define further embodiments of the invention.

The invention, its embodiments and further advantages will be described in the following with reference to the following drawings.

### BRIEF DESCRIPTION OF THE DRAWINGS

FIGS. 1a and b represent vertical cross sections through a shuttle-type metered dose valve of the prior art including a valve stem comprising an elongate stem element and a sealing element.

FIGS. 2a and b represent vertical cross sections through two preferred embodiments of a valve stem.

FIGS. 3a and b represent vertical and horizontal cross-sections through another preferred embodiment of a valve stem having a non-circular cross-section

FIG. 4 represents a horizontal cross-section through yet another embodiment of a valve stem having a non-circular cross-section.

### DETAILED DESCRIPTION

It is to be understood that the present invention covers all combinations of particular and preferred aspects of the invention described herein.

For a better understanding of the present invention, an exemplary dispensing valve of the prior art, which may advantageously include a valve stem in accordance with the present invention, will be initially described.

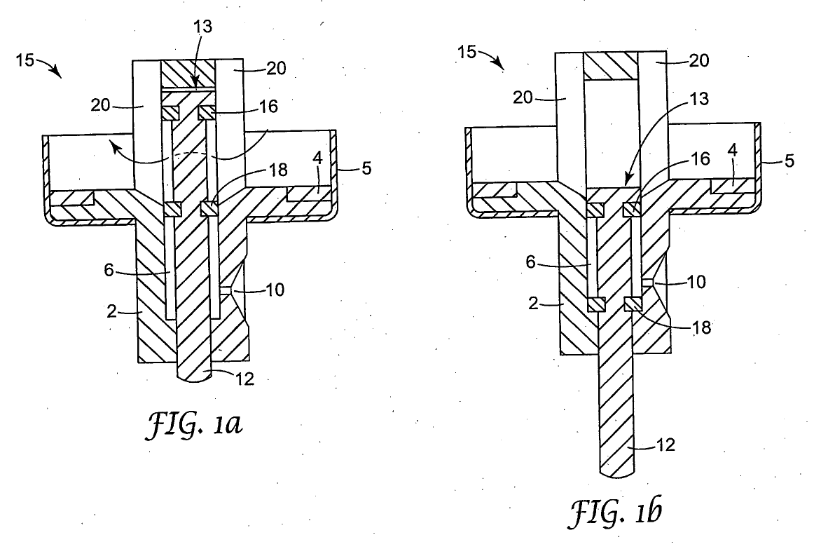

FIGS. 1a and b illustrate an exemplary shuttle-type metered dose dispensing valve, disclosed in U.S. Pat. No. 5,772,085 and incorporated herein by reference. Referring to FIGS. 1a and b, the valve (15) typically comprises a body (2) having an annular gasket seal (4) for engaging the neck of an aerosol container or vial (not shown) to facilitate a gas-tight seal. The body (2) may be secured to the aerosol container or vial by any suitable means e.g. a conventional outer casing or ferrule (5), which is crimped around the neck of the aerosol container. As can be best seen in FIG. 1b, the body (2) defines a chamber (6) having an outlet passage (10) for dispensing e.g. pressurized medicinal aerosol formulation. The valve stem (13) comprising an elongate stem element (12) extends through the chamber (6) and is movable between a closed or priming position (as shown in FIG. 1a) and a dispensing position (as shown in FIG. 1b). The elongate stem element (12) is provided with an inner seal (16) and outer seal (18), desirably in the form of annular seals, which provide gas-tight seals between the valve stem and the inner wall of the chamber (6). The chamber (6), external dimensions of the valve stem (13) and the positions of the seals (16 and 18) are arranged to define a pre-determined volume within the chamber (6) between the seals (16 and 18). This can be best understood by reference to FIG. 1b showing the valve in its dispensing position. As can be seen in FIG. 1a, in its closed or priming position the space between the seals (16 and 18) around the valve stem (13) extends into the reservoir containing aerosol formulation. As the valve stem (13) moves downwardly to its dispensing position, the seal (18) moves down the chamber allowing free access of the aerosol formulation into the chamber (6). Further movement of the valve stem causes seal (16) to enter the chamber (6) thereby trapping a metered volume of aerosol formulation between the seals (16 and 18) and the interior wall of the chamber (6). When the valve stem reaches its dispensing position the seal (18) passes outlet passage (10) thereby allowing direct communication between the metered volume and the outlet passage (10) thereby allowing the metered volume of formulation to be dispensed. In the illustrated valve, the valve is arranged, in particular the cross-sectional area of the seals (16 and 18) is arranged, such that the valve stem will be biased outwardly towards its dispensing position by vapor pressure generated by pressurized aerosol formulation contained within the container of the dispenser. The alignment of the valve stem may be ensured by ribs (20) which do not obstruct the free flow of aerosol formulation (as depicted by the arrow in FIG. 1a) around the valve stem (13) between the seals (16 and 18).

It is to be understood that Figures la and b show one exemplary dispensing valve, which may be modified to comprise a valve stem in accordance with the present invention, and that other dispensing valves, in particular other metered dose dispensing valves, having a valve stem comprising an elongate stem element and at least one sealing element arranged onto the elongate stem element, may also desirably include a valve stem in accordance with the present invention. Further examples of appropriate metered dose dispensing valves are described in our co-pending U.S. application 60-408637; the contents of which are incorporated herein by reference.

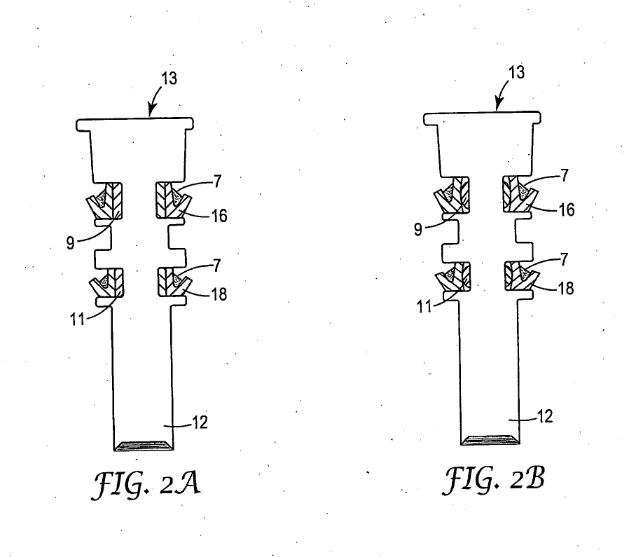

Valve stems in accordance with the invention comprise an elongate stem element having an elastomeric sleeve molded onto at least a portion of the elongate stem element and at least one sealing element affixed onto the elongate stem element, such the at least a portion of the internal surface of the sealing element is overlying a portion of the elastomeric sleeve. This can be better understood by reference to e.g. a preferred embodiment of the valve stem illustrated in FIG. 2a. Here the elongate stem element (12) of the valve stem (13) includes two elastomeric sleeves (9,11) molded onto the elongate stem element. Two sealing elements (16, 18), which are illustrated here as annular seals having a complex, undercut geometry, are affixed, e.g. mechanically attached, on the elongate stem element, such that their inner surfaces (generally indicated by reference number 7) overlay the elastomeric sleeve. In the embodiment shown in FIG. 2a, the entire inner surfaces (7) of the sealing elements (16,18) overlay the elastomeric sleeve (9,11), in particular the outer surface of the sleeve. It will be appreciated that the valve stem can be arranged, such that only a portion of the inner surface overlays the elastomeric sleeve. This can be best seen in an alternative embodiment of the valve stem as shown in FIG. 2b, where only a portion of the inner surface (7) of each sealing element (16,18) overlays the elastomeric sleeve (9,11). Also as illustrated by the embodiments shown in FIGS. 2a and b, the elastomeric sleeve may be straight sided or convex-shaped. Alternatively the elastomer sleeve may incorporate additional structures, such as raised sealing beads and/or locating grooves. It will be appreciated that the elastomeric sleeve may, if desired, extend beyond one or both ends of the sealing element, such that the entire or only a portion of the inner surface of the sealing element overlays only a portion of the elastomeric sleeve.

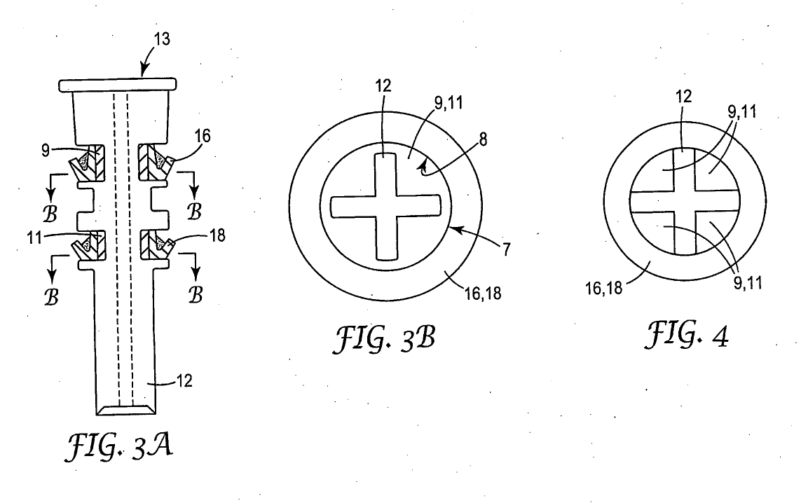

As can be recognized from the embodiments illustrated in FIGS. 2a and b, the provision of valve stems comprising mechanically fitted sealing elements having a complex geometry and at the same time having desirably resistance to leakage is facilitated. The provision of valve stems having an elongate stem element with a non-circular, e.g. a cross-shaped, cross-section with an annular sealing element can also be advantageously facilitated. This can be better understood by reference to FIGS. 3a and b, illustrating another preferred embodiment of the valve stem in a vertical and a horizontal cross-section, respectively. As can be best seen in FIG. 3b the elongate stem element (12) of the valve stem (13) has a non-circular cross-section, a cross-shaped cross-section. For elongate stem elements made of a material comprising a polymer such a cross-shaped form can be advantageous in their manufacture via injection molding, because the molded -element shows desirable cooling properties with a corresponding minimal tendency towards deformation and non-uniform shrinkage. The elastomeric sleeves (9, 11) are molded onto the elongate stem element, and as can be best seen in FIG. 3b, the outer surface (8) of each sleeve is desirably substantially circular in its cross-section. As shown in FIGS. 3a and b, annular sealing elements (16,18) are affixed onto the elongate stem element with their inner surfaces (7) overlying the elastomeric sleeve. The embodiment shown in FIGS. 3a and b exemplifies how the application of such a molded sleeve, i.e. whose outer surface has a substantially circular cross-section, in combination with an elongate stem element having a non-circular cross-section, desirably facilitates the mechanical fitting of an annular sealing element onto such an stem element. As can be seen in FIG. 4, showing a horizontal cross-section of another valve stem embodiment including a cross-shaped elongate stem element (12), the molded sleeve (9,11) may be formed of four quadrant portions with the inner surface of annular sealing element (16,18) thus overlying the outer surface of each quadrant of the sleeve and the outer surface of each projection of the elongate stem element. As can be appreciated from the embodiments shown in FIGS. 2 and 3 and best seen in FIG. 3b, the elastomeric sleeve preferably extends continuously around the elongate stem element (about its longitudinal axis), so that once the sealing element is affixed onto the stem element, at least a portion of the inner surface of the sealing element overlays circumferentially at least a portion of the elastomeric sleeve.

The elongate stem element may be made of metal or a material comprising a polymer.

Suitable metals include stainless steel, aluminum and titanium. For metallic elongate stem elements, the elastomeric sleeve is molded onto at least a portion of the elongate stem element using molding procedures well-known in the art.

For elongate stem elements made of a material comprising a polymer, suitable polymers include acetal, nylon, polyester (PE), in particular polybutylene terephthalate (PBT), polymethylpentene (MP), polyphenylenesulfide (PPS), polyaryletherketones (PAEKs), thermotropic liquid crystalline polymers (LCPs), polypropylene, high density polypropylene, ethylene-tetrafluoroethylene copolymer (ETFE), poly-vinylidene difluoride (PVDF) and mixtures thereof. The material may include typical fillers, such as fibers (e.g. glass, mineral or carbon fibers), minerals (e.g. CaCO₃), graphite or carbon, which may enhance structural robustness. Nylon-, PPS- and PBT-containing materials desirably incorporate fillers, e.g. made of glassfiber, while the other polymer-containing materials are desirably free of fillers. When applying polymeric materials including fillers, such as glass-fibers, it is desirable that the gate region for molding of the elongate stem element is positioned such that it will underlie the elastomeric sleeve, in order to subsequently prevent filler being exposed to formulation, e.g. medicinal aerosol formulation, contained within the container equipped with a valve including the valve stem.

Suitable PAEK polymers include polyetherketone, polyetheretherketone, polyetheretherketoneketone, polyetherketoneetherketoneketone and polyetherketoneketone; polyetheretherketone is preferred.

Suitable LCPs include main-chain or side-chain LCPs, more particular comprising rigid-rod-like macromolecules. Suitable polymer classes of LCPs include e.g. polyamides, polyesters and polycarbonates as well as polypeptides, polyoxamides, polyhydrazide, polyazomethine, polyisocyanide, polyisocyanate, polyorganophosphazine, metal-polyine and cellulose derivate, such as ethylcellulose and hydroxypropylcellulose. Preferred LCPs are copolyesters, copolyamides and polyester-amides, while LCPs comprising linear ester or ester/amide bonds are more preferred.

For use in valve stems in valves for delivery of medicament, the polymer is desirably non-toxic and/or recognized for use in medicinal products. Suitable grades for application in valve stems for metering dose valves for the delivery of medicament include for example non-filled polyetheretherketones PEEK™ 381G and 450G (available through Victrex, Lancashire, UK); non-filled and mineral-filled polyester-based LCPs VECTRA™ A950 and A530, respectively (available through Ticona, Kelsterbach, Germany); non-filled PMP TPX™ RT18 (available through Mitsui Chemicals, Düsseldorf, Germany); and glassfiber-filled PPS, FORTRON™ 9140L4 and 9140L6 (also available through Ticona); PBT medical grade CELANEX™ 2402MT (also available through Ticona); PBT 30% glass-fibre filled CELANEX™ 3314 (also available through Ticona); POM Hostaform™ C9021 (also available through Ticona); polypropylene MOPLEN™ VM 300P (available from Basell, Hoofddorp, Netherlands); high density polypropylene HOSTALEN™ GC 7260 (also available from Basell); ETFE TEFZEL™ 207 (available from DuPont, Wilmington, USA) and DYNEON™ PVDF (available from 3M, St Paul, USA).

For elongate stem elements made of a material comprising a polymer, preferably the elastomeric sleeve is co-molded onto at least a portion of the elongate stem element. Under the term “the elastomer sleeve is co-molded onto at least a portion of the elongate stem element” is to be understood that the elastomeric sleeve is chemical and/or mechanical bonded to at least a portion of the elongate stem element as the result of a co-molding process used in the manufacture of the valve stem.

The elastomeric sleeve may be made of a material comprising a thermoplastic elastomer or a thermoset elastomer; preferably a thermoplastic elastomer for desirable ease in manufacturing and co-molding.

Various classes of suitable thermoplastic elastomers include polyester rubbers, polyurethane rubbers, ethylene vinyl acetate rubber, styrene butadiene rubber, copolyester thermoplastic elastomers, copolyester ether thermoplastic elastomers, olefinic thermoplastic elastomers, polyester amide thermoplastic elastomers, polyether amide thermoplastic elastomers, copolyamide thermoplastic elastomers and mixtures thereof. Examples of olefinic thermoplastic elastomers are described in WO 92/11190, which is incorporated herein by reference, and include block copolymers of ethylene with monomers selected from but-1-ene, hex-1-ene and oct-1-ene. Other examples of suitable olefinic thermoplastic elastomers are described in WO 99/20664, which is incorporated herein by reference, and in U.S. Pat. No. 5,703,187 (Dow). Styrene-ethylene-butadiene-styrene copolymers and blends, such as those described in WO 93/22221 and WO 95/03984, both of which are incorporated herein by reference, as well as styrene-ethylene-propylene-styrene copolymers are suitable thermoplastic elastomers. An example of a polyether amide thermoplastic elastomer is PEBAX (Atofina), which is a polyether-block-co-polyamide. Compositions comprising a mixture of inter-dispersed relative hard and relative soft domains may also be employed as suitable thermoplastic elastomers. Examples of such mixture compositions include SANTOPRENE (Advanced Elastomer Systems) which has thermoset EPDM dispersed in a polyolefin matrix or ESTANE (Noveon) which is a polymer of segmented polyester urethanes with a mixture of crystalline and rubbery nanophases. Other mixtures include olefinic thermoplastic/rubber blends and polyvinyl chloride/rubber blends. Other possibilities include single-phase melt-processable rubbers and ionomers.

The desired thickness of the elastomeric sleeve typically depends on the particular structural form of the elongate stem element and the sealing element. However a suitable minimal thickness may be about 0.1 mm, more suitably about 0.2 mm and even more suitably about 0.3 mm. A suitable maximal thickness may be about 1.5 mm, more suitably about 1.0 and even more suitably about 0.5 mm.

The sealing element is typically an annular seal. The sealing element is typically elastomeric and may be made of a material comprising a thermoplastic elastomer or a thermoset elastomer. Suitable thermoplastic elastomers for the sealing element include those mentioned in connection with the elastomeric sleeve.

The provision of valve stems comprising a sealing element made of a material comprising a thermoset elastomer is facilitated. Co-molding of thermoset elastomeric sealing elements and elongate stem elements, in particular elongate stem elements comprising thermoplastic polymer, is often precluded due to material considerations and/or in some cases practicability. For example, valve stems including a sealing element made of a material comprising a thermoset elastomer and an elongate stem element made of a material comprising an acetal polymer, co-molding of the two elements is typically precluded due to material incompatibility. Therefore, preferred embodiments of valve stems including an elongate stem element made of a material comprising a polymer, more particular a thermoplastic polymer, and a sealing element made of a material comprising a thermoset elastomer are particularly beneficially provided.

Preferred thermoset elastomers include thermoset ethylene-propylene-diene terpolymer (EPDM), acrylonitrile-butadiene copolymer (Nitrile rubber), isobutylene-isoprene copolymer (Butyl rubber), halogenated isobutylene-isoprene copolymer (e.g. Chlorobutyl rubber and Bromobutyl rubber), polychloroprene (Neoprene), and mixtures thereof, with EPDM, nitrile rubber and butyl rubber being more preferred, EPDM and nitrile rubber even more preferred and EPDM most preferred.

A preferred method of manufacturing a valve stem in accordance with the invention comprises the steps of:
a) providing an elongate stem element;
b) providing a mold shape containing at least in part the elongate stem element;
c) molding a material to form an elastomeric sleeve, such that the elastomeric sleeve is molded onto at least a portion of the elongate stem element.
d) affixing a sealing element onto the elongate stem element, such that at least a portion of the inner surface of the sealing element is overlying at least a portion of the elastomeric sleeve.

For preferred embodiments of the valve stems comprising an elongate stem element made of a material comprising a polymer, step a) of providing an elongate stem element desirably comprises the steps of:
i) providing a first mold shape;
ii) molding a first material to form the elongate stem element.
   Step b) would then be providing a second mold shape, while step c) would then be molding a second material to form the elastomeric sleeve. The molding of step c) is desirably performed, such that the elastomeric sleeve is co-molded onto at least a portion of the elongate stem element.

An alternative, preferred method of manufacturing a valve stem embodiment comprising an elongate stem element made of a first material comprising a polymer comprises the steps of:
a) providing a second mold shape;
b) molding a second material to form the elastomeric sleeve;
c) providing a first mold shape underlying at least in part the elastomeric sleeve; and
d) molding a first material comprising a polymer to form the elongate stem element having the elastomeric sleeve co-molded onto at least a portion of said elongate stem element; and
e) affixing the sealing element onto the elongate stem element, such at least a portion of the inner surface of the sealing element is overlying at least a portion of the elastomeric sleeve.

For the sake of consistency in the two alternative methods, the wording “first” mold shape and “first” material are used here in connection with steps relating to the molding of the elongate stem element, while the wording “second” mold shape and “second” material are used in connection with steps relating to molding of the elastomeric sleeve, regardless of the sequential order of the process steps. For molding of the elongate stem element and/or molding of the elastomeric sleeve, the preferred method of molding is injection molding.

It will be appreciated by those skilled in the art that respective mold shapes will be provided as to allow the provision of the particular form of elongate stem element and elastomeric sleeve needed for the use of the valve stem in the particular dispensing valve. The method may involve a molded component being removed from its mold and then positioned appropriately in another mold form for the molding of the other component. Alternatively the method may involve a single, repositionable or form-changeable mold, in which upon molding of a component, the mold is re-positioned or changed to provide the appropriate form shape for molding of the other component.

For valve stems comprising two or more elastomeric sleeves, those skilled in the art will appreciate that each individual elastomeric sleeve may be molded simultaneously or sequentially, and that each individual elastomeric sleeve may have a different form, as needed or desired, and/or may be made of a different material, again as needed or desired. For valve stems comprising two or more sealing elements, again those skilled in the art will appreciate that each individual sealing element may have a different form, as needed or desired, and/or may be made of a different material, again as needed or desired.

Metered dose dispensing valves comprising a valve stem in accordance with the invention as well as metered dose dispensers comprising a container equipped with such a metered dose valve are desirable for use in dispensing medicament, in particular medicinal aerosol formulation, due to the advantageous properties of the valve stems. The use of valve stems in accordance with the invention in conjunction with medicinal aerosol formulations comprising a medicament and a propellant selected from 1,1,1,2-tetrafluoroethane, 1,1,1,2,3,3,3-heptafluoropropane and a mixture thereof, more particular further comprising ethanol, is particularly desirable

A preferred metered dose dispensing valve, suitable for dispensing metered volumes of a pressurized aerosol formulation, comprising a valve stem in accordance with the invention, is a valve which further comprises a chamber and an outlet passage, wherein the valve stem extends into the chamber and movable relative to the chamber between non-dispensing and dispensing positions, the valve stem having a configuration including an external surface and the chamber having an internal configuration including an internal surface such that a movable metered volume of pressurized aerosol formulation is capable of being defined therebetween and such that during the movement between its non-dispensing and dispensing positions the valve stem sequentially:
i) allows free flow of aerosol formulation into and out of the chamber;
ii) defines a closed metered volume for pressurized aerosol formulation between the external surface of the valve stem and internal surface of the chamber, and
iii) moves with the closed metered volume within the chamber without decreasing the volume of the closed metered volume until the metered volume communicates with the outlet passage thereby allowing dispensing of the metered volume of pressurized aerosol formulation.

The valve stem desirably comprises a second elastomeric sleeve, said second elastomeric sleeve molded onto at least a portion thereof, and a second sealing element, said second sealing element having an inner surface and being arranged and affixed onto the elongate stem element, such that at least a portion of the inner surface of the sealing element is overlying at least a portion of the elastomeric sleeve, and being longitudinally spaced from the first sealing element, each sealing element having a sealing surface capable of forming a gas-tight seal with the internal surface of the chamber.

1. A valve stem for use with a metering valve, said valve stem comprising an elongate stem element having an elastomeric sleeve molded onto at least a portion thereof and a sealing element having an inner surface, said sealing element being affixed onto the elongate stem element, such that at least a portion of the inner surface of the sealing element is overlying at least a portion of the elastomeric sleeve.

2. A valve stem according to claim 1, wherein the elongate stem element is made of a metal or a material comprising a polymer.

3 A valve stem according to claim 2, wherein the elongate stem element is made of a material comprising a polymer and the elastomeric sleeve is co-molded onto at least a portion of the elongate stem element.

4. A valve stem according to any preceding claim, wherein the elongate stem element is made of a material comprising a thermoplastic polymer.

5. A valve stem according to any preceding claim, wherein the elastomeric sleeve is made of a material comprising a thermoplastic elastomer.

6. A valve stem according to any preceding claim, wherein the sealing element is elastomeric.

7. A valve stem according to any preceding claim, wherein the sealing element is made of a material comprising a thermoplastic elastomer or thermoset elastomer.

8. A valve stem according to claim 6, wherein the sealing element is made of a material comprising a thermoset elastomer selected from EPDM, nitrile, butyl rubber, chlorobutyl rubber, bromobutyl rubber and neoprene.

9. A method of manufacturing a valve stem for use with a metering valve, said valve stem comprising an elongate stem element, an elastomeric sleeve and a sealing element, said method comprising the steps of:
a) providing an elongate stem element;
b) providing a mold shape containing at least in part the elongate stem element;
c) molding a material to form the elastomeric sleeve, such that the elastomeric sleeve is molded onto at least a portion of the elongate stem element; and
d) affixing the sealing element onto the elongate stem element, such at least a portion of the inner surface of the sealing element is overlying at least a portion of the elastomeric sleeve.

10. A method of manufacturing a valve stem according to claim 9, wherein said mold shape and said material is the second mold shape and second material; wherein the elongate stem element made of a first material comprising a polymer and step a) of providing an elongate stem element comprising the steps of:
i) providing a first mold shape;
ii) molding a first material to form the elongate stem element,
and wherein in step c) molding is performed, such that the elastomeric sleeve is co-molded onto at least a portion of the elongate stem element.

11. A method of manufacturing a valve stem for use with a metering valve, said valve stem comprising an elongate stem element, said elongate stem element made of a first material comprising a polymer, an elastomeric sleeve and a sealing element, said method comprising the steps of:
a) providing a second mold shape;
b) molding a second material to form the elastomeric sleeve;
c) providing a first mold shape underlying at least in part the elastomeric sleeve; and
d) molding a first material comprising a polymer to form the elongate stem element having the elastomeric sleeve co-molded onto at least a portion of said elongate stem element;
e) affixing the sealing element onto the elongate stem element, such at least a portion of the inner surface of the sealing element is overlying at least a portion of the elastomeric sleeve.

12. A method of manufacturing according to claim 10 or 11, wherein the step of molding elongate stem element is injection molding.

13. A method of manufacturing according to any one of claims 9 to 12, wherein the second material comprises a thermoplastic elastomer.

14. A method of manufacturing to any one of claims 9 to 13, wherein the step of molding the elastomeric sleeve is injection molding.

15. A metered dose dispensing valve comprising a valve stem according to any one of claims 1 to 8.

16. A metered dose dispensing valve according to claim 15, said valve being suitable for dispensing metered volumes of a pressurized aerosol formulation and wherein said valve further comprises a chamber and an outlet passage, wherein the valve stem extends into the chamber and is movable relative to the chamber between non-dispensing and dispensing positions, the valve stem having a configuration including an external surface and the chamber having an internal configuration including an internal surface such that a movable metered volume of pressurized aerosol formulation is capable of being defined therebetween and such that during the movement between its non-dispensing and dispensing positions the valve stem sequentially:
i) allows free flow of aerosol formulation into and out of the chamber;
ii) defines a closed metered volume for pressurized aerosol formulation between the external surface of the valve stem and internal surface of the chamber, and
iii) moves with the closed metered volume within the chamber without decreasing the volume of the closed metered volume until the metered volume communicates with the outlet passage thereby allowing dispensing of the metered volume of pressurized aerosol formulation.

17. A metered dose dispensing valve according to claim 16, wherein said valve stem a second elastomeric sleeve, said second elastomeric sleeve molded onto at least a portion thereof, and a second sealing element, said second sealing element having an inner surface and being arranged and affixed onto the elongate stem element, such that at least a portion of the inner surface of the sealing element is overlying at least a portion of the elastomeric sleeve, and being longitudinally spaced from the first sealing element, each sealing element having a sealing surface capable of forming a gas-tight seal with the internal surface of the chamber.

18. A metered dose dispenser comprising a container equipped with a metered dose dispensing valve according to any one of claims 15 to 17.

19. A metered dose dispenser according to claim 18, wherein the container contains a medicinal aerosol formulation.

20. A metered dose dispenser according to claim 19, wherein the medicinal aerosol formulation comprises a medicament and a propellant selected from 1,1,1,2-tetrafluoroethane, 1,1,1,2,3,3,3-heptafluoropropane and a mixture thereof

21. A metered dose dispenser according to claim 20, wherein the formulation further comprises ethanol.
